(19) United States
(12) Patent Application Publication
(10) Pub. No.: US 2002/0129106 A1
(43) Pub. Date: Sep. 12, 2002

(54) User-extensible system for manipulating information in a collaborative environment

(75) Inventor: Steven H. Gutfreund, Brighton, MA (US)

Correspondence Address: PEPPER HAMILTON LLP, ONE MELLON CENTER, 50TH FLOOR, 500 GRANT STREET, PITTSBURGH, PA, 15219, US

(73) Assignee: Surgency, Inc.

(21) Appl. No.: 09/802,993

(22) Filed: Mar. 12, 2001

(51) Int. Cl. G06F 15/00; G06F 17/00

(52) U.S. Cl. 709/205; 707/530

(57) ABSTRACT

A browser-based system and method for creating, modifying, communicating, displaying and sharing information in a collaborative environment, is disclosed. The present invention provides an architecture and system for assembling and creating searchable, archivable, interactive collaborative spaces over the Internet that can be changed by anyone at any time. This is achieved in part by writing each collaborative component/application used in the collaborative environment in Extensible Markup Language (XML), as opposed to conventional Hyper-Text Markup Language (HTML).

### FIELD OF INVENTION

The present invention generally relates to the field of collaborative search tools. More particularly, the present invention relates to an architecture and system for assembling and creating a wide variety of searchable, archivable, interactive and distributed collaborative applications that are user-definable and can be changed by anyone at any time.

### BACKGROUND OF INVENTION

With the increasing use and availability of the Internet today, communication of information has dramatically changed. Generally speaking, the Internet is an arrangement of networks that interconnect a plurality of computers and telecommunications links, used for locating and accessing information globally.

The information available on the Internet embodies several forms and includes text, still images, such as paintings or pictures, moving images (i.e. video), with and without sound, and graphics. In other words, Internet users can access, manipulate and/or transmit music videos, speeches, pictures, movie clips, cartoons, databases, government forms, and the like.

The way in which these various forms of information are managed on the Internet is through the use of hypertext. Hypertext is a database format in which information related on a display can be accessed directly from the display by using links or hyperlinks. Links are generally either text based (words) or icons (pictures/symbols). Accordingly, users who access information on the Internet that are displayed on a screen can move to desired information by simply pointing and clicking on words or symbols/pictures.

Information accessed through the Internet is invariably presented via a web page. Each web page is generally written in Hyper-Text Markup Language (HTML) since the Internet is hypertext based. HTML is a methodology for populating or marking up information (i.e. files or documents) with tags that provides instructions on the manner in which the information should be presented and linked. Each web page also has a unique address; namely a Universal Resource Locator (URL). A compilation of web pages comprise a web site that can be linked together.

The technology used to access information in a web page is accomplished using a browser. Like the web page, the browser is another essential component to Internet use. A browser is essentially a software program designed for reading the HTMLs in web pages; it facilitates access and movement between web pages.

From a user perspective, once the log-on procedure is completed, a user activates a web-based browser and an initial web page, which is generally the default home page for a web site. Typical browsers include Microsoft Internet Explorer and Netscape Navigator.

In some applications on the Internet that support real-time interpersonal communications, multiple users maintain a common browser view. In other words, all users are able to view the same web pages displayed on their web browsers via their display screen. This class of applications includes Internet-based video telephony, where users can communicate using voice and video over the Internet, and collaborative tools, which allows users at differing physical locations to simultaneously view and/or interact with the same data.

There are several collaborative tools on the market today. One tool is video conferencing, which allows users at remote locations to hold a conference over the Internet. Video and audio signals are transmitted over standard communications networks with the aid of videoconferencing software to computers generally equipped with at least a camera, microphone and earphones or speakers.

Another collaborative tool is a whiteboard, which allows multiple users at remote locations to share notes and diagrams. Text and/or graphics signals are transmitted over standard communications networks to computers generally equipped with drawing tools like pens and geometric shapes, and tools that allow users to import pictures.

Other collaborative tools include, for example, a chat program, shared pointer and distributed pasteboard. A chat program is basically the electronic equivalent of daily interpersonal communications either in-person (i.e. talk chat and video chat), or over the telephone (i.e. voice chat). Talk chat allows multiple users to converse (exchange typed remarks) without having to leave their display screen. Video chat enhances the conversation by allowing each user to view another user during the conversation. Voice chat allows multiple users to hear the voice of another user.

Using a shared pointer, multiple users can each manipulate the pointer to alter the visible appearance (i.e. color, size, shape) of an object as desired. Changes made by one user's pointer is viewed by all other users.

Developers of collaboration tools include Zaplet Inc., which transforms email content into a web page content; PlaceWare, Inc., which offers online white-boarding, conferencing and application sharing; Lotus, which offers online calendaring and application sharing; and Microsoft, which offers similar applications.

Collaborative tools are generally divided into two categories: synchronous and asynchronous. Both categories of collaborative tools provide a first level of communication between other users located at different physical locations. Synchronous collaborative tools allow multiple users to share information to other users who are simultaneously connected at the same time to a computer network. Asynchronous collaborative tools allow multiple users to share information at staggered times (i.e. not simultaneously).

Integration of all collaborative tools into the web has produced one fundamental shortcoming; they cannot be used flexibly. Specifically, existing collaborative tools that have been applied to the Internet all employ HTML embedding of a web page. In terms of ability to extend functionality, the collaborative tool is static, because it is fixed by the HTML of the web pages. Existing collaborative tools are incapable of many convenient changes desired by a novice Internet user because any change to the tool would require a corresponding change to the tool's scripting language embedded in a web page, a task far beyond the capability of the average computer user. Therefore, a need exists for a real-time collaboration environment that is not statically fixed by program designers and the like, and that is multi-purpose and user-definable in design, content and delivery.

### SUMMARY OF THE INVENTION

The foregoing needs have been satisfied to a great extent by the present invention which includes a customizable, browser-based system and method for communicating, sharing and displaying information in a collaborative environment where a novice user can easily assemble and create one or more collaborative web spaces. These collaborative spaces can be used for distance learning, team meetings, collaborative trouble-shooting of applications, as consulting rooms for a client or for multi-player games.

A basic building block of each collaborative space or application comprises a collaborative component or an electronic business tool. There are a wide variety of ebusiness tools including spreadsheets, telephony, two-dimensional and three-dimensional charts, buttons, drop-down menus, PowerPoint slide presentation viewers, clocks, sliders and the like. Other sophisticated tools for special purpose business needs include CAD/CAM and project planning, for example.

In a preferred embodiment of the present invention, each of these tools are divided into three parts: information describing its: (1) visual representation (i.e. the look, shape or color characteristics) of the tool; (2) functionality (i.e. how the tool functions); and (3) code (i.e. the definition parameters that drive operability). Using the system of the present invention, a novice computer user can manipulate as desired varying parameters of the visual representations and functionalities of each business tool contained in a collaborative environment.

This is achieved through an architecture that is structured as a star network. Each network comprises a central core of servers (i.e. server cloud) that provide the storage and processing functions necessary to not only support each collaborative component (i.e. each ebusiness tool), but also to support a truly flexible, user-extensible collaborative web space, which comprises a group of modularly-assembled collaborative components.

One key aspect of the architecture is that collaborative components substantially reside in the server, rather than in the web browser. As such, substantially all collaborative web spaces are stored on a network of web servers. This allows users to enjoy a number of advantages, including the ability to join a collaborative web space at any time, or to leave and rejoin that web space later.

Other advantages include the ability to interact with collaborative components as an individual or a team, or to be able to start a session on one workstation and finish on another (or remotely located) workstation. Additionally, whatever work was performed during the course of a collaborative meeting is saved, and thus becomes archivable, by the web server. These and other advantages also serve to highlight the functional use of the web browser as a “thin client” in providing an interactive graphical user interface (GUI) display.

In a preferred embodiment, there are three major layers of the present invention. The first layer comprises a storage layer in the form of one or more storage databases or servers used to store the data for each collaborative component and/or web space. Data generally includes information on the visual representation of each collaborative component, its functionalities, the code responsible for viewing the component, text, and the like.

Substantially all of the data stored on the server is represented in extensible markup language (XML), rather than in conventional hyper-text markup language (HTML). User or client-computer requests and retrievals are directed to the server, which records the requested information and disseminates the information so that other browsers can view and retrieve the same information.

The storage layer provides more than just a place for permanent archival storage of collaborative web spaces. It is also designed to provide event-driven computations. For example, for spreadsheets requiring very large calculations, the spreadsheet can be re-designed using daemon services to trigger computations to occur inside the server only, and simply post the results when computations are completed.

In addition, the storage layer is also designed to implement federated services, which are brokered transactions performed by service broker daemons that are invoked by a triggering activity. In one instance, posting of an electronic travel request to fly to New York would invoke a travel agent daemon contacting all the necessary travel services (i.e. airline, hotel, car rental, theatre tickets, etc.) to fulfill the user's request(s).

The second major layer of the present invention comprises an interconnecting layer in the form of one or more collaboration servers or orchestrators. The primary responsibility of each orchestrator is to ensure accurate and timely replication of information among each platform or connected workstation.

Through the orchestrator, any computer or workstation in the network has equivalent capabilities and responsibilities. The orchestrator facilitates user interface requests or events between the server and user, so that changes or updates in a collaboration application are communicated to other users. It resides principally in the server cloud and facilitates dynamic on-the-fly creation of client-side collaborative components.

Lastly, the third major layer of the present invention is directed to at least one blackboard interface, which functions to translate every collaborative component in XML into a sharable object or element. The blackboard communicates all changes made to a collaborative component or web space to the web server and the orchestrator. Through the blackboard, new components to a collaborative web space such as an appointment book, post-it note or the like, may be added very simply and dynamically. Optionally, new or existing components can be removed or replaced easily. The blackboard is also responsible for communication between components via a publish/subscribe mechanism.

In another aspect of the present invention a process of assembling collaborative components, is disclosed. The process is one of building assemblies of collaborative components into a user-desired sharing environment called workspaces or component assemblies or WidgetBenches.

The process includes, in part, the steps of:

selecting one or more collaborative component by a user from a WidgetTray component (which itself is a collaborative component) and visually placing each component on a display screen by direct manipulation;

using an XML editor to customize the look and feel of the collaborative component; and saving the customized component to the server.

In yet another aspect of the present invention a collaborative software suite, is disclosed. In a suite in accordance with one embodiment of the present invention, non-programmers or novice computer users can rapidly craft new collaboration environments or web spaces over the Internet because the collaborative software suite is an extensible toolkit of packaged collaborative applications. Each toolkit can be rapidly assembled as desired to create a variety of collaborative spaces; namely, formal meetings, brainstorming sessions, large classrooms, workshops, one-on-one problem solving, and the like. For instance, programmers can extend the suite of collaborative components represented in the WidgetTray, and non-programmers can assemble components into larger multi-component applications.

Each collaborative application exists inside the web browser, essentially allowing a user to exploit the web browser as a universal delivery mechanism. Additionally, in each collaborative application a user or participant can go back at any time and explore what was done in each application at any point of the collaboration. Thus, archival searches can be performed on meetings to ascertain what was being done by a particular user at a particular time.

In one embodiment of the collaborative software suite, it is packaged as comprising a control panel, a WidgetTray or menu of collaborative component options, and an Editor.

The control panel exists in every collaborative environment or web space, in two forms; collapsed, or expanded as a menu. The control panel provides basic maintenance operations such as Save, Load, Switch, Edit and Dump.

A second aspect of the collaborative software suite is the WidgetTray feature, which provides a user with a menu of collaborative component options in the visual form of an icon. In one embodiment, the WidgetTray includes twelve buttons representing twelve collaborative components that a user can select to populate and assemble into a desired sharing environment (or WidgetBench). These components include: (1) Text; (2) Button; (3) Plain; (4) Slider; (5) Flash tools; (6) Slides; (7) Note posting; (8) Video; (9) Scrolling text; (10) Spreadsheet; (11) Tree list; and (12) Charts. As pointed out earlier, programmers can easily add new components to the WidgetTray to provide new functionality.

A third aspect of the collaborative software suite is the Editor. The Editor is the primary mechanism by which a user can change or modify desired parameters of a collaborative application. It displays a specified data structure portion of the XML tree for each collaborative application.

In yet another aspect of the invention, a user-extensible system for sharing and displaying information in a collaborative environment over the Internet, is disclosed. The user-extensible system comprises a web browser for communicating collaborative application changes to one or more users substantially simultaneously; one or more servers configured to store and process data for each application; one or more orchestrators configured to provide dynamic creation of a user-defined collaborative application, wherein each orchestrator is configured to communicate with the server and a blackboard interface; and a blackboard interface configured to translate each collaborative application into a sharable object.

Each collaborative application is substantially represented in extensible markup language (XML). Moreover a user-extensible aspect of the system is provided by user capability to modify or customize a parameter of a collaborative as desired. Another user-extensible aspect of the system is provided by user capability to modify or customize different ways of representing the same collaborative application information as desired, such as changing the size, color, text formatting, shape, etc.

Each collaborative application substantially resides in the one or more servers. In addition, each orchestrator substantially resides in the one or more servers. Operation of each orchestrator provides each connected computing device with substantially equivalent capabilities, and enables centralized and compartmentalized information sharing. A computing device may include a desk-top personal computer (PC), laptop, pager, cellular telephone, palm pilot, television and the like.

The blackboard interface substantially resides in the user computing device, and provides sharable functionalities. Also, the web browser provides the delivery vehicle for the collaborative environment.

In another aspect of the invention, a computer architecture for supporting an Internet collaborative environment is provided. The architecture comprises one or more servers configured to store and process data for each collaborative application, where the server includes at least one orchestrator in which substantially all data is stored and/or processed in extensible markup language (XML). The orchestrator provides automatic distributed replication of information.

The architecture also comprises a blackboard configured to translate each collaborative application in XML into a sharable object. The architecture is open-ended and platform-independent.

Each collaborative application resides in the one or more servers. And each sharable object is maintained in a single data structure to facilitate simple and fast data queries.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangement of the components set forth in the following description or illustrated in the drawings. The invention is capable of other embodiments and of being practiced and carried out in various ways. Also, it is to be understood that the phraseology and terminology employed herein as well as the abstract included below are for the purpose of description and should not be regarded as limiting.

For completeness, it is to be understood that the instant invention is equally applicable to any standard network of computers, of which the Internet is an example. Such networks of computers, for example, include a standard communications protocol such as Transmission Control Protocol/Internet Protocol (TCP/IP), Open Systems Interconnection (OSI) protocol, User Datagram Protocol (UDP), Wireless Application Protocol (WAP), and/or Bluetooth wireless communications protocol, or any other network-type protocol, local and/or global.

As such, those skilled in the art will appreciate that the conception upon which this disclosure is based may be readily utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of an exemplary home page in accordance with a preferred embodiment of the present invention.

FIG. 2 is a perspective view of another embodiment of the home page of FIG. 1.

FIG. 3 is a perspective view of another embodiment of the home page of FIG. 1, showing components of a Personal eStrategy Briefing Book.

FIG. 4 is a perspective view of another embodiment of the home page of FIG. 1.

FIG. 5 is a diagram of an architecture of the present invention, in accordance with one embodiment.

FIG. 6 is a more detailed diagram of the interconnect layer shown in FIG. 5.

### DETAILED DESCRIPTION OF PREFERRED EMBODIMENTS

Unlike collaborative environments available on the market today, the present invention is not statically fixed by the designers. It is not a single-purpose application crafted by skilled web programmers to support a particular mode and methodology of collaboration.

The present invention provides a new and innovative way for real-time and live collaboration, especially for geographically dispersed individuals, over the Internet by using user-definable extensible markup language (XML) rather than the high-level, programming hyper-text markup language (HTML) in its collaborative applications. It is an environment for sharing web applications, not just one web application, that anyone can use to create and assemble collaborative web spaces.

The system is user-extensible; that is, it is easily modified by novice computer users that can add new and/or additional collaborative components to provide new/ different/additional functionalities. In this regard, it is not statically fixed by designers.

Some of the basic defining characteristics of the present invention includes: (1) a highly interactive, multi-user environment for shared brainstorming; (2) interactions occurring in either real-time or sequentially with the option of transforming an existing non-real-time forum to a shared, real-time collaboration; (3) a forum for creating distributed meetings with searchable meeting archives, in part, of knowledge created during the meeting; (4) a general-purpose toolbox for assembling custom collaborative spaces; (5) RAD web site design; (6) support for live media collaboration, including audio and video; (7) support of plug-in interactive tools, such as financial and business-readiness assessment tools; (8) the ability to cascade collaborative components to create large sub-assemblies of components; (9) the ability of shared spaces to persist after users exit the collaborative environment, and then later re-enter the environment to continue the collaboration; and (10) the ability of each collaborative space to be changeable at run-time by each user without programming.

Customization of the instant browser-based system and method for creating, modifying, communicating, sharing and displaying information in a collaborative environment, is achieved by user editing of desired XML parameters directly on a display screen, as will be described in more detail herein below.

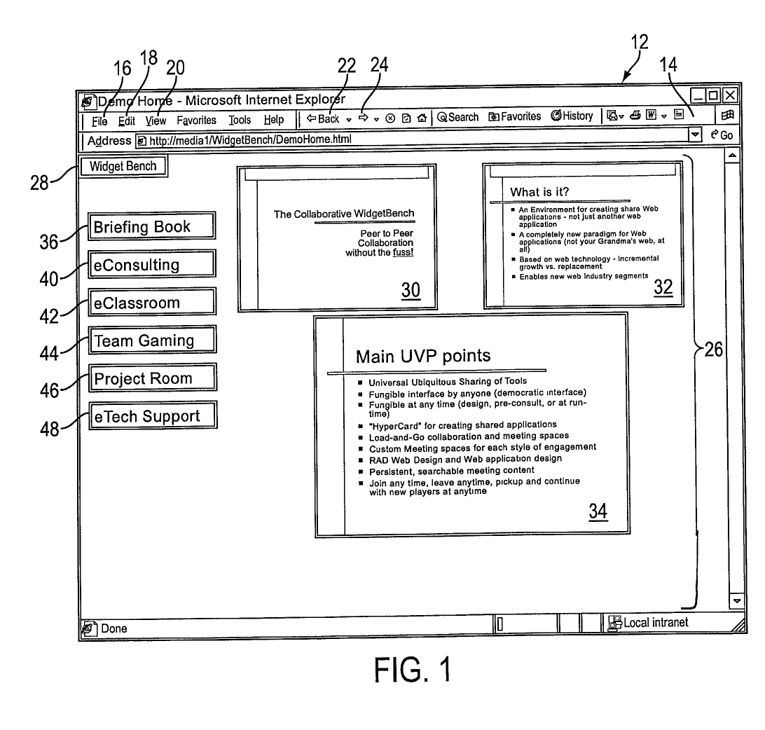

Referring now to FIG. 1, there is shown an exemplary home page 12 of the present invention. In the embodiment shown, the present invention is referred to as the collaborative “WidgetBench” that employs webcentric network collaboration. It operates in a conventional browser; namely, Microsoft Internet Explorer.

Several menus for Internet Explorer are shown in FIG. 1. A menu is an on-screen list of options and commands available to a user. Menu row 14 shows, for example a File menu 16, Edit menu 18, View menu 20, etc. These menus enable a user to open a new browser, or open a file, edit a file or view reveal codes of a file, and the like.

As an alternative to menus, buttons can be employed to provide added functionality. Menu row 14 also shows a Back button 22 and forward button 24 (in the form of an arrow) that allows a user to go backwards and forwards, respectively, through a history list. Selecting one of these buttons can show additional information, as desired.

There is a window 26 that holds the contents of the collaborative environment to which the present invention is directed. Window 26 is generally a rectangular area on a display screen used to hold or present information pertaining to a particular aspect of the browser currently in operation. It serves as an inventory-keeping function of the number of collaborative tools or applications being displayed. Window 26 includes, among other things, six access buttons representative of six different collaborative applications, a control panel 28 and three shared PowerPoint components 30, 32, 34.

More specifically, the six collaborative applications are: (1) a strategy Briefing Book 36; (2) a live meeting room, eConsulting 40; (3) eClassroom 42, which facilitates a teacher/student learning environment; (4) Team Gaming 44, which facilitates a variety of games by multiple players; (5) Project Room 46, which allows project team members to share ideas; and (6) eTech Support 48, which facilitates discussion between technical support and users.

WidgetBench can be used in a variety of application contexts. For instance, the present invention can be used as a virtual consulting collaborative tool used to create and populate a virtual meeting space with the appliances that are needed for a client meeting. The client meeting may be formal, a brainstorming session, a follow-up, tutorial, joint investigation, and the like. This application can be represented on the display screen by a virtual consulting button or icon.

Key features for virtual consulting can include: creation of unique meeting spaces tailored to each customer; corporate pre-load of standard methodology and tools into customized meeting spaces (i.e. simulation tools, documents, power point slides, Return On Investment (ROI) spreadsheets, project plans, etc.); easy end-user customization of templates to respond to customer needs; supports pre-loading of methodology, content and tools; supports multiple meeting paradigms (i.e. brainstorm, formal meeting, etc.); highly interactive; multi-media elements; all elements (e.g. a project plan) that inhabit the meeting space are inheritable, editable and modifiable. For example, a project plan that is placed in a meeting can be interactively experimented on by a client or consultant and then saved.

Distance Learning is another application of the present invention. Distance Learning is closely related to virtual consulting. However, there are some unique aspects to distance education that would be inappropriate in a consulting environment. An exemplary use of the present invention for more classroom-style engagement is characterized in an exemplary embodiment by the following:

1. A teacher preloads power point slides and/or simulation experiments into a virtual space;

2. The teacher proceeds to give a formal class with slides and demonstrative simulation examples to the class;

3. The teacher only partially completes the simulation examples;

4. The teacher then assigns the completion of the simulation as well as other related simulations as 'lab work' to student teams;

5. Students proceed to work interactively together on the assignment;

6. The teacher can either look at saved completed work, or dynamically “look over the lab bench” where the students are working and manipulate and guide the students.

Alternatively and optionally, the present invention can readily be employed as a collaborative development tool for companies involved in creating web sites for clients. It provides plugable modularity (e.g. search module, chart display, calendar functions, tabular display, etc.) for any part of a web site. It can also be used in an online collaborative design session with a client, where elements are pasted in (much like a cut-up, paste-up coloring book) to create a prototype of a new web site.

In addition, the results of the WidgetBench collaboration can be saved and a pointer provided to the client as a working prototype. In other words, an actual working model that may even be the final design, is the tangible end result using the present invention, not just a visual mock-up as typically done.

The present invention can also be used in a standalone mode where, for example, a company can use it internally in a non-collaborative mode to rapidly paste together collaborative web spaces.

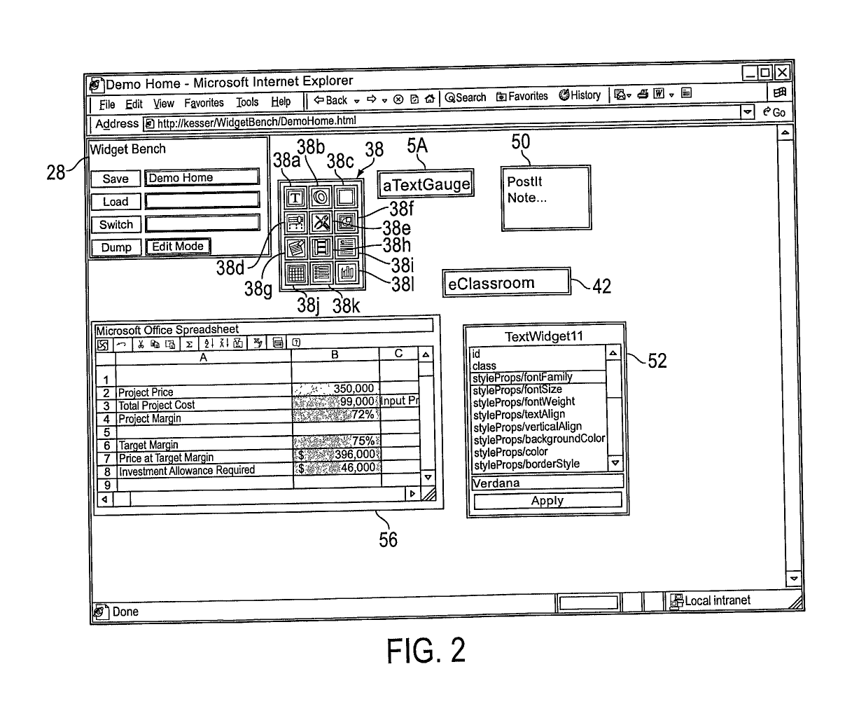

Referring now to the figures, wherein like reference numerals indicate like elements, in FIG. 2, there is shown an expanded control panel 28, achieved after depressing the control panel button (as shown in FIG. 1). The control panel 28 provides basic maintenance operations. It allows a user to invoke commands, for example, to Save, Load another collaborative tool, Switch between various tools, go into Edit mode, and Dump.

In further detail, the Save feature is used for saving, such as in saving a desired collaborative component to the storage layer, such as database 90 in server cloud 94. The Load feature allows a single user to load a collaborative component (or WidgetBench) from the storage layer. The Switch feature essentially loads a desired collaborative component, from the storage layer, simultaneously for every user connected to a current collaborative web space. The Edit feature allows a user to manipulate a collaborative component; namely to add, delete, and modify individual components in a WidgetBench, for example. The Dump feature allows a user to view the XML representation of all current collaborative components.

In addition to the above-mentioned six collaborative applications 36, 40, 42, 44, 46, 48 and control panel 28 shown in the window 26 of FIG. 1, there is also shown a WidgetTray 38, which provides a user with a menu of collaborative component options in the form of a visually descriptive button or icon.

In the embodiment shown in FIG. 2, WidgetTray 38 comprises twelve buttons representing a different application a user can employ to build a desired and customized collaborative environment. A detailed discussion of each icon is provided below.

For example, depressing the Text button 38a creates or instantiates a collaborative text component that can be used to display a single line of text.

The Button 38b instantiates a collaborative button, which can be edited to post values to other components. For example, it can be configured to change the label of a text component when pressed. Alternatively, it could be used to invoke server-based operations. In addition, it can be used to inform the server to perform the switch operation to load a new collaborative component or WidgetBench.

The Plain button 38c allows a user to add to the current collaborative WidgetBench one or more components that can display HTML elements.

The Slider button 38d is used in a similar manner to Button 38b. However, instead of posting a text value to the XML representation of the WidgetBench, the Slider button 38d posts a numeric value. Examples of the use of the Slider feature include controlling the value of a spreadsheet cell or controlling the width or height of another collaborative component, and the like.

The Flash button 38e provides the capability of adding to the component assemblies such interactive tools like Macromedia Flash™, which allows users to create high quality multimedia interactive tools. The Personal eStrategy Briefing Book 36 which shows a three-dimensional graphing tool to show 3-D data is one exemplary use of a flash tool 60. Generally, this button 38e allows for sophisticated analysis of data visually.

The Slides feature 38f provides for the viewing of PowerPoint presentation slides, for example. Combining the Slider feature 38d with the Slides feature 38f, a user can jump from slide number one to slide number five, for instance.

The Note posting feature 38g is merely a yellow PostIT™ annotation on top of text, whereby users can write notes to themselves or others. This feature can also be used as a simple shared chat facility.

The Video feature 38h allows users to watch videos. It also facilitates video- and/or audio-conferencing.

The Scrolling text feature 38i, unlike the Note posting feature 38g, allows a user to type in large blocks of text with a scroll bar on at least one side.

The Spreadsheet feature 38j facilitates manipulation of data and/or text in spreadsheet format. Here, the spreadsheet is connected to its underlying XML data representation. Any change in the data (e.g. via a Slider tool, direct user typing into a cell, or other interconnections between tools) will result in the spreadsheet recalculating its value(s).

The Tree list feature 38k allows users to create tree lists, such as agendas.

The Charts feature 381 allows a user to insert interactive two-dimensional chart objects into a WidgetBench. These charts have a similar appearance to charts commercially available such as those found in Microsoft Excel. However, the present charts are capable of dynamically responding to changes in their underlying data structure, similar to the above spreadsheet feature.

It is important to recognize that the window 26 shown in FIG. 2 shows the result of using the WidgetTray 38 to add collaborative components to the initial display that was shown in FIG. 1. These additional collaborative components include, for instance, PostIt® note 50, Editor 52, aTextGuage component 54, and a spreadsheet component 56.

The spreadsheet component 56 allows in part a user to organize and perform mathematical manipulations of numerical data and text. The PostIt® note-taking component 50 facilitates free-form note-taking of information. The aTextGuage component 54 is a user-changeable labeling feature. It allows a user to add a label to a WidgetBench that will respond to changes in the underlying XML data. In this instance, component 54 shows the label “aTextGuage”. However, button 54 can be configured to post new data to the XML store to change the label to “DONE”, for example, or any other desired information or label.

Another mechanism by which a user can change or modify desired parameters of a collaborative application is represented by an Editor 52. Editor 52 displays a specified data structure portion of the XML tree for a collaborative application. It is a simple way of editing any aspect of the look and feel of each collaborative component. In the embodiment shown in FIG. 2, editor 52 directs changes made to spreadsheet 56. A user is therefore able to modify such variables as a collaborative component's font type, font size, background color, alignment of text, borders, and the like.

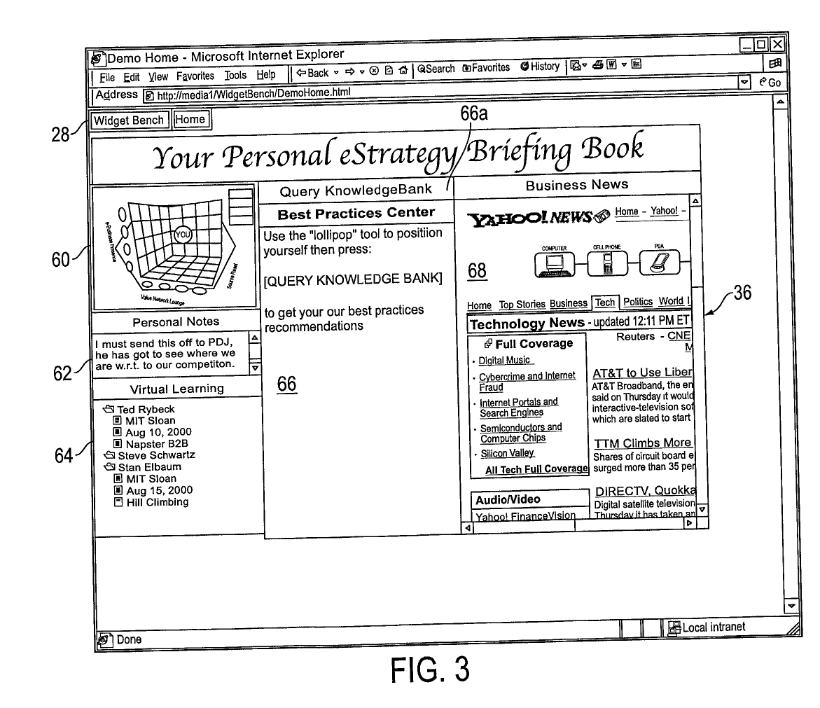

FIG. 3 is another embodiment of the present invention, showing the various applications customizable to create a Personal eStrategy Briefing Book 36, the collaborative application represented by the button “Briefing Book” in the window 26.

The Briefing Book 36 includes several components: a flash tool 60 that presents in 3D the relative position of a company with respect to its competitors, relative to specified parameters; a note-taking application 62 entitled, “Personal Notes”, to record and save a user's personal notes regarding, for example, the strength and weaknesses of a company; a listing application 64 of virtual learning educational videos of various people; a query knowledge bank button 66a that can be pressed to select, for example, corporate best practices recommendations on the desired issue which are displayed in region 66. In addition, the business news website component 68 will also be updated with the corporate best practices information. In this embodiment, the business news website component 68 displayed is Yahoo! News.

In a preferred embodiment, all of these collaborative components shown in FIG. 3 are “wired” together to provide an integrated collaborative sharing environment such that when a user positions the ball in 3D space contained within flash component 60, this positional information (i.e. the x-y-z coordinates) is provided through the wiring mechanism to the query knowledge bank button 66a. In other words, when button 66a is depressed, only a small set of best practices information that corresponds to the position of the ball in 3D space, is retrieved and displayed in region 66. Additionally, button 66a will fill the website component 68 with business news that is filtered by the criteria expressed by flash component 60.

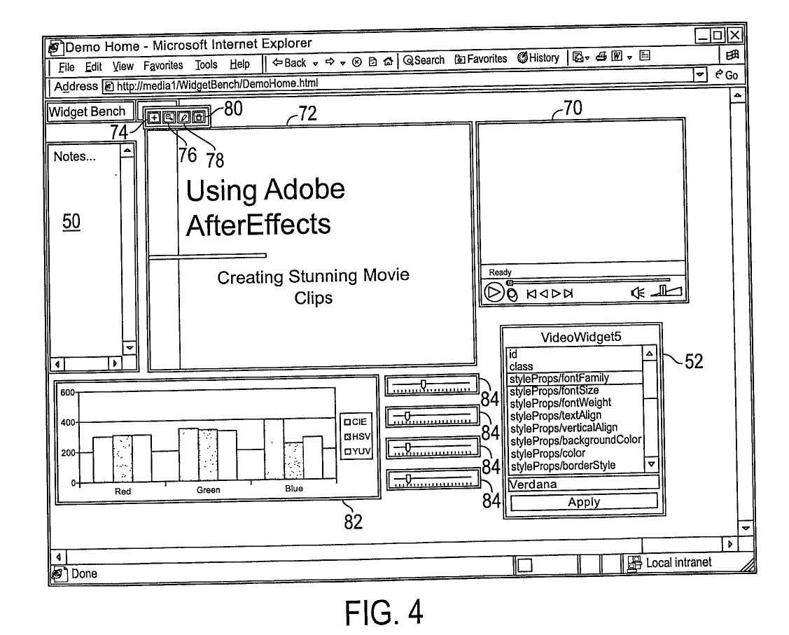

Alternatively and optionally, other applications can be added as components to a user's desired collaborative environment. Referring to FIG. 4, a video 70 and power point slide presentation 72 are customizable collaborative components, as shown. Associated with the power point slide 72 are four editing control icons 74, 76, 78, 80 for moving, resizing, editing and deleting functions, respectively. Preferably and optionally, these four editing icons 74, 76, 78, 80 can be associated with each collaborative component.

Additionally, another collaborative component may be a simulation-type application 82, configurable to display charts and the like. In yet another embodiment, a slider 84 may be added. Each slider 84 controls a particular aspect of color, for example, associated with the simulation-type application 82. One aspect may be the hue, having a range from red to blue as the slider is moved from left to right, for example. Another slider 84 may be configured to control the color saturation level, having a range from high to low as the slider is moved from left to right. Movement of the slider results in changes to appropriate bars in the simulation component 82.

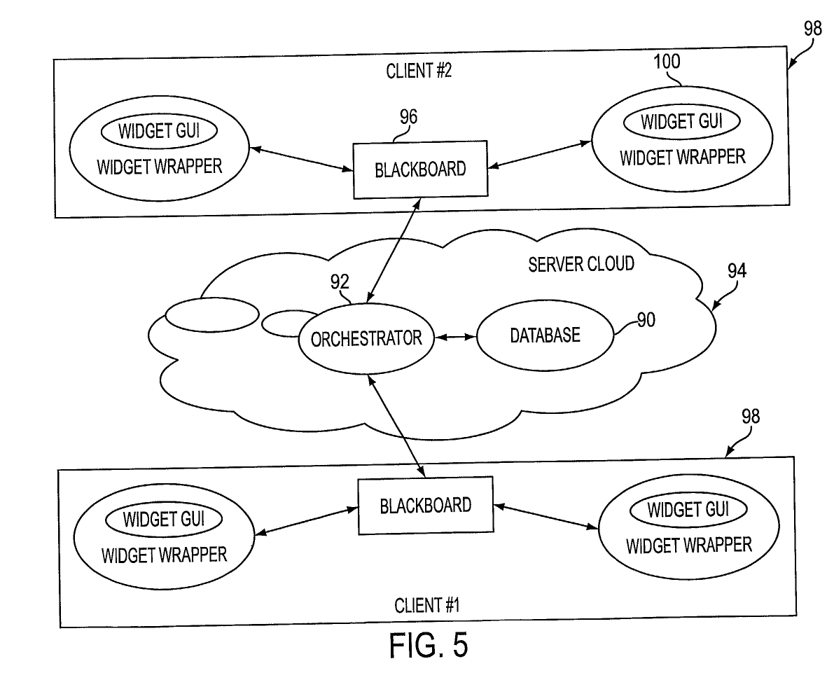

In a preferred embodiment, the architecture supporting the user-extensible collaborative environment of the present invention is depicted in FIG. 5. It comprises several components.

One component is one or more storage databases or servers 90 used to store data for each collaborative application. Data generally includes information on the visual representation of each collaborative component, information on the code responsible for viewing the component, text, and the like.

Substantially all data about each collaborative component and each collaborative web space is maintained in XML format. That is, the description of the archival collaborative web space in database 90, the active copy of each collaborative web space in the orchestrator 92 and in each blackboard 96, as well as the XML data for each collaborative component, comprises one common data structure. Substantially all of the data stored in extensible markup language (XML), which resides in the orchestrator 92, is transformed into display codes on the browser side at run time. Hence, the orchestrator 92, database 90 and blackboard 96 communicate and coordinate with each other to ensure the maintenance of a single synchronized copy of the data.

User requests and retrievals are directed to server cloud 94, which records the requested information and disseminates that information so that other browsers can retrieve the same information. Server cloud 94 comprises one or more databases 90 and orchestrators 92.

In addition to permanent archival storage of collaborative web spaces, the server cloud 94 is also designed to provide event-driven calculations and to implement federated services upon a triggering activity. In one instance, very large computations can be designed to occur inside the server cloud 94 only to avoid delays on a user's personal computing device. In another instance, brokered transactions can be invoked by a triggering activity and performed even during the user's absence. Results are simply posted and/or displayed upon completion, as desired.

In a preferred embodiment, one or more orchestrators 92 and databases or servers 90 comprise the server cloud 94. Server cloud 94 enables sharing and displaying of information in a collaborative environment. Preferably, server cloud 94 is web-centric and comprises one or more servers where data is stored and shared. Universality of shared components, data and personalization is maintained by server cloud 94. Server cloud 94 also supports a plurality of workstations or clients 98, and provides automatic distributed replication of information among these clients 98.

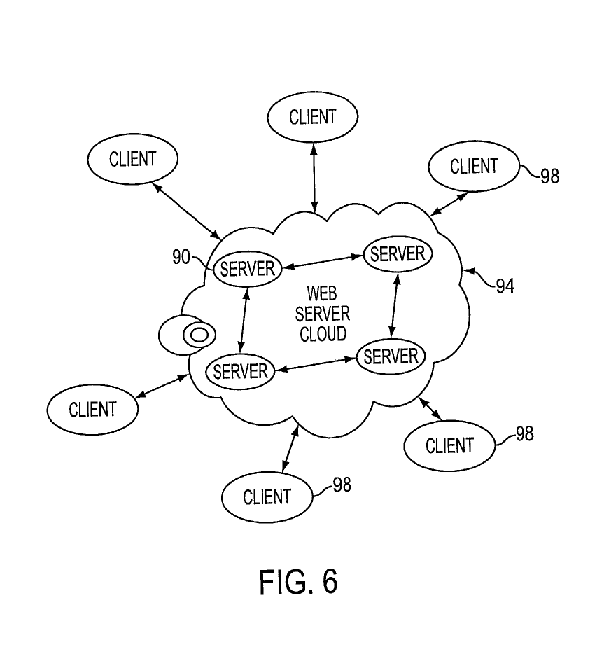

There are several advantages of the star network arrangement of FIG. 6, in particular, and of the present invention, in general. One important advantage is that much of the load and management tasks is moved to the central servers in the server cloud 94. In addition, server cloud 94 does not require considerable consumption of client resources, such as disk memory, network bandwidth, and the like.

Another feature and advantage is the centralized and compartmentalized knowledge sharing via a controlled security network model. A third feature and advantage is the leveraging of current web applications already widely available to users or clients. By layering on accepted technology, the present invention does not require a paradigm shift by users/clients.

Fourth, many of the security issues pertinent to web services can be addressed by using a secure backend-environment. Fifth, the present invention enables compatibility with very thin clients, such as Internet telephony applications.

Yet another feature and advantage of the present invention is that it provides a continuum of different modes of interaction. For example, user autonomy to enter, exit and move around different collaborative environments as desired, is available with the present invention. Moreover, it is possible for a receiving user to go offline (i.e. not be connected to a particular collaborative application), work on another project, and then re-join the collaborative discussion and see what is displayed on everyone's screen. Additionally, each collaborative application is changeable by any user at any time.

Referring again to FIG. 5, another component in the architecture of the present invention comprises an interconnect layer in the form of one or more orchestrators 92. In a preferred embodiment, an orchestrator 92 facilitates communications between the server cloud 94 and a blackboard interface 96, which resides in each client's computing device, such that user interface requests or events between the server and user are communicated to other users.

The orchestrator 92 resides principally in the server cloud 94 and is primarily responsible for ensuring accurate and timely replication of information among each platform or connected workstation. Through the orchestrator 92, any computing device or workstation has equivalent capabilities and responsibilities.

The orchestrator 92 is capable of handling many simultaneous collaborative sessions at one time. (FIG. 5 illustrates one active session between two clients 98.) The orchestrator 92 maintains a copy of all information about a collaborative component. Accordingly, users or clients 98 are free to save a desired collaborative component or collaborative web space to the database 90 at any time, and to retrieve archived copies thereof.

Additional services provided by the orchestrator 92 include: broadcasting or disseminating the deletion and/or addition of collaborative components to a collaborative web space; implementing a ‘follow-me’ mode of communications by switching all connected users from one collaborative component to another at the directive of a client 98 who is acting as a leader; synchronizing new clients 98 to join a collaborative web space that is already being used; as well as handling cleanup when users are disconnected.

The orchestrator 92 is a key ingredient to providing the ability for creating collaborative spaces that one can join at any time. Users can join in or exit working collaborative web spaces and be immediately synchronized to the current state of that collaborative space. Alternatively, one user can continue to work on a collaborative space, and then later invite others to join in and continue to collaboratively share his or her work. Alternatively and optionally, a collaborative space can be tagged as private such that it can not be viewed by others, even though the space has been disseminated.

Another architecture component of the present invention comprises a blackboard interface 96 that generally handles: (1) disseminating changes that occur in one collaborative component to other components within a particular client 98; (2) informing the orchestrator 92 of these changes; and (3) receiving changes from the orchestrator 92 that occurred on another client 98 and disseminating these changes inside each client 98.

Interface 96 allows a user to change any parameter of a collaborative component or web space easily, and have those changes communicated to the server 90 and reflected on a display screen. As such, interface 96 functions to translate every collaborative tool component in XML into a sharable object.

The blackboard interface 96 generally resides in a user or client's computing device. As shown in FIG. 5, each client 98 has two collaborative components 100 that communicate with each other via blackboard interface 96. Interface 96 also provides the desirable function of scalability to many users, such as several hundred users, for simultaneous viewing. This function is accomplished through publish and subscribe features.

For example, the publish command operates to transmit and/or display information, such as a user request or updated information, from a workstation to the blackboard 96 and ultimately to the server 90. The subscribe feature operates to ‘sense’ the occurrence of a particular event; namely, the change of the XML data that is being controlled by the blackboard 96. As stated earlier, changes are invoked by modifications in each collaborative component by (local or remote) client 98.

For example, if a user drags a collaborative component to a new location, the new location is disseminated to the blackboard 96, which in turn informs all components that are subscribing to this information. The blackboard 96 also informs the orchestrator 92 of the change so that it can relay the new location to other clients 98.

Through the blackboard 96, new components to a collaborative web space such as an appointment book or the like, may be added very simply and dynamically. Optionally and alternatively, new or existing collaborative components can be removed or replaced easily.

The code for each collaborative component 100 is generally comprised of two parts: the graphical user interface (GUI) component and the Wrapper component. The GUI component subsists within the Wrapper component, as shown in FIG. 5.

The GUI component is the portion of each collaborative component concerned with transforming an XML representation and rendering it as a visual graphic. It also handles the user interaction with each collaborative component. The GUI component may be implemented using either the JavaScript or Java programming language, or ActiveX controls, Macromedia Flash, or a combination of all four languages. Other conventional languages may be used.

Using Microsoft Internet Explorer with ActiveX controls, for example, allow users to see video and animation, hear sound, as well as run programs in graphics-base and text-based web pages. Also, GUI component may be written using JavaScript and Flash, which facilitates 3D graphics viewing. Other implementations include Java, VBScript and other web-browser-friendly languages.

The Wrapper component is essentially script code that manages the XML data associated with the collaborative component, as well as the communication with the blackboard 96. The Wrapper component in turn comprises two parts: the base wrapper portion, which is common to all collaborative components; and a custom wrapper portion a small part of which is written by programmers.

There is a clear separation between the data that describes each collaborative component and its GUI component, which generally controls visual representation. This allows clients 98 to easily ‘re-skin’ a collaborative component to look and act differently. For example, using the system and architecture of the present invention, a user can change a chart representing sales figures in bar chart into an interactive spreadsheet that allows the user to explore what-if scenarios based on different sales figures.

One feature enabled by the blackboard 96 is the ability to replace GUI controls for a collaborative component based on user preferences or platform differences. One example illustrative of the above and how a user can manipulate transmission/display of information into a desired format, is video conferencing. For example, if two individuals in a collaborative web space are video conferencing with an audio component, and a third team member, who has a Palm Pilot™, is unable to receive the video and audio components of the collaborative meeting, a translator component can be attached to the blackboard 96 that is capable of transmitting closed captioning text of the discussion taking place to the PalmPilot™.

Similarly, on a workstation where mouse control is difficult, for example, direct video interpretation of hand motions or speech could be used to control different GUI dials and gauges.

In another mode and application, the blackboard 96 also allows configuration of a control panel for television station selection to control a video collaborative component. For example, the control panel is able to retrieve personal favorite information either from database 90 or through the use of federated services, in order to provide customized automated program control for video display, such as through using a station selector to select television stations.

Interactive controls can also be added to a collaborative web space. For example, slider controls to a chart in the Distance Learning application previously discussed, can be added to manipulate individual bars in a bar chart. Using the collaborative web space in this way is analogous to attaching test and instrumentation equipment to monitor and control a working machinery.

The responsiveness of the system is grounded in the fact that each collaborative component is custom designed to direct which information or computation is to run on the client's computing device and which information is implemented in the server cloud 94. Unlike remote terminal programs like pcAnywhere™, or application sharing systems like PlaceWare™ or NetMeeting™, the present invention is capable of determining whether it would be more responsive to perform desired computations, for example, on the server or not.

The security model of the present invention is based on meta-data attached to XML elements. In a preferred embodiment, each XML element is attached an Access Control List (ACL) that grants or denies read/write/modify/delete controls for any client 98. Security restrictions are additive as one proceeds down the XML tree. From the application layer, this means that one can specify a general level of security to an entire collaborative web environment, and/or more specific access to particular collaborative components and/or control parameters to access a particular collaborative component properties, such as screen location, or the ability to change a particular field in a spreadsheet, for example.

From an application and/or user perspective, the present invention provides a flexible security system. For instance, security mechanisms are configurable to implement such features as locking a collaborative web environment so that only one user at a time can manipulate it, or so that one person is allowed to take notes only while other members/users engage in a shared text chat that is visible only to the latter team members.

In other systems, users can use passwords to upload and download files to a web server from their web browser. However, with the present invention the granularity of access is not on a file-by-file basis, but rather on individual sub-properties of an XML tree.

The above description and drawings are only illustrative of preferred embodiments that achieve the objects, features and advantages of the present invention, and it is not intended that the present invention be limited thereto. Any modification of the present invention that comes within the spirit and scope of the following claims is considered to be part of the present invention.

What is claimed is:

1. A user-extensible system for creating, displaying and sharing information in a collaborative environment over the Internet, said user-extensible system comprising:
(a) a web browser for communicating collaborative application changes to one or more users substantially simultaneously;
(b) one or more servers configured to store and process data for each application;
(c) one or more orchestrators configured to provide dynamic creation of a user-defined collaborative application; said one or more orchestrators configured to communicate with said one or more servers and a blackboard interface; and
(d) a blackboard interface configured to translate each collaborative application into a sharable object.

2. The system according to claim 1, wherein each application in said collaborative environment is substantially represented in extensible markup language.

3. The system according to claim 1, wherein a user-extensible aspect of said system is provided by user capability to modify or customize a parameter of a collaborative application as desired.

4. The system according to claim 3, wherein said user capability includes modifying or customizing a parameter of an active collaborative application as desired.

5. The system according to claim 3, wherein said user capability includes modifying or customizing a parameter of an inactive collaborative application as desired.

6. The system according to claim 1, wherein a user-extensible aspect of said system is provided by user capability to modify or customize different ways of representing the same collaborative application information as desired.

7. The system according to claim 1, wherein each collaborative application substantially resides in said one or more servers.

8. The system according to claim 1, wherein substantially all changes occurring at each user computing device is tracked and saved on said one or more servers.

9. The system according to claim 1, wherein each orchestrator substantially resides in said one or more servers.

10. The system according to claim 9, wherein operation of each orchestrator provides each connected computing device with substantially equivalent capabilities.

11. The system according to claim 1, wherein said blackboard interface substantially resides in a user computing device.

12. The system according to claim 1, wherein said one or more orchestrators enables centralized and compartmentalized information sharing.

13. The system according to claim 1, wherein the web browser is a component of the collaborative environment.

14. The system according to claim 1, wherein said blackboard interface provides sharable functionalities.

15. The system according to claim 14, wherein said sharable functionalities include disseminating changes that occur in one collaborative component to another or more connected collaborative components.

16. A computer architecture supporting a web-based collaborative environment, said architecture comprising:
(a) one or more servers configured to store and process data for each collaborative application, said one or more servers including at least one orchestrator where substantially all data is stored in extensible markup language (XML); and
(b) a blackboard configured to translate each collaborative application in XML into a sharable object.

17. The architecture according to claim 16, wherein said architecture is open-ended and platform-independent.

18. The architecture according to claim 16, wherein each application resides in said one or more servers.

19. The architecture according to claim 16, wherein each sharable object is maintained in a single data structure.

20. The architecture according to claim 16, wherein said at least one orchestrator provides automatic distributed replication of information.

21. A collaborative software suite for manipulating XML-based information in a collaborative environment, said suite comprising an editor function for modifying and displaying a specified data structure portion of an XML tree for each collaborative component, for adding and deleting one or more collaborative components, and for providing maintenance operations.

22. The collaborative software suite according to claim 21, wherein each collaborative space in said collaborative environment is changeable at run-time by a user without programming.

23. The collaborative software suite according to claim 21, wherein each shared collaborative space persists after exit by one or more users, such that said shared collaborative space can be later re-entered by said one or more users to continue the collaboration.

24. The collaborative software suite according to claim 21, wherein each collaborative component is configurable in a cascade arrangement to create one or more large sized sub-assemblies of components.

25. The collaborative software suite according to claim 21, wherein said suite is user-extensible such that a user can add one or more additional components to add functionality.

26. The collaborative software suite according to claim 21, wherein the editor function allows a user to change or modify desired parameters of said collaborative component.

27. The collaborative software suite according to claim 21, wherein the editor function allows a user to edit any aspect of the look and feel of each collaborative component.

28. The collaborative software suite according to claim 21, wherein the editor function for providing maintenance operations comprises at least one of save, load, switch, edit and dump features.

29. The collaborative software suite according to claim 28, wherein the save feature substantially invokes one or more commands to save information to storage from a user's computing device.

30. The collaborative software suite according to claim 28, wherein the load feature substantially invokes one or more commands to load information from storage to the current collaborative environment.

31. The collaborative software suite according to claim 28, wherein the edit feature substantially invokes one or more commands to enable at least one of manipulation and modification of information.

32. The collaborative software suite according to claim 28, wherein the dump feature substantially invokes one or more commands to view XML representation of a collaborative component.

33. The collaborative software suite according to claim 21, wherein the editor function further provides a menu of collaborative component options in the visual form of an icon.

34. The collaborative software suite according to claim 21, wherein said menu of collaborative component options includes at least one of a text, button, plain, slider, flash tool, slides, note posting, video, scrolling text, spreadsheet, tree list and chart buttons.

35. The collaborative software suite according to claim 34, wherein said menu of collaborative component options represent collaborative components that a user can select to populate and assemble into a desired collaborative sharing environment.

36. The collaborative software suite according to claim 21, wherein said suite is user-extensible such that a user can add one or more additional collaborative components to add functionality.

37. A method of building assemblies of collaborative components into a user-desired sharing environment, said method including the steps of:
(a) selecting one or more collaborative components from a menu of options;
(b) visually placing each collaborative component on a screen by direct manipulation; and
(c) using an XML editor to customize a look and feel of each collaborative component as desired.

38. The method according to claim 37, further including a step of saving the assembled collaborative components to a server.

39. The method according to claim 37, wherein the building process includes passive viewing of the collection of collaborative components.

40. The method according to claim 37, wherein the building process includes active manipulation or modification of each collaborative component as desired.

41. A collaborative software suite comprising a collaborative environment employing an editor for manipulating XML-based information such that a user can manipulate collaborative components on a display screen, by at least one of adding, deleting, resizing, controlling placement of, and modifying features of each collaborative component.
